(19) United States
(12) Patent Application Publication
(10) Pub. No.: US 2010/0263557 A1
(43) Pub. Date: Oct. 21, 2010

(54) TATTOO STENCIL PRINTING SYSTEM AND USE OF THE SAME

(75) Inventor: Cristopher Hicks, Fort Worth, TX (US)

Correspondence Address: JOHN LINDSAY, 5427 JOHNSON DR., SUITE 127, SHAWNEE MISSION, KS, 66205, US

(73) Assignee: HD Stencil Printer, LL

(21) Appl. No.: 12/427,718

(22) Filed: Apr. 21, 2009

(51) Int. Cl. B05C 17/08; B41M 1/12

(52) U.S. Cl. 101/126; 101/129

(57) ABSTRACT

The tattoo stencil printing system is an impact printer useful for creating high resolution, high quality tattoo stencils. The impact printer has a specialized print head with an impact designed for a specific transfer medium. A method of using the tattoo stencil printing system is provided which includes providing a source image to the system and generating a tattoo stencil.

### FIELD OF THE INVENTION

The present invention relates to a system for printing tattoo stencils, more specifically to a system for printing and using high quality, high resolution tattoo stencils for use in the tattooing process.

### BACKGROUND OF THE INVENTION

Decoration of the human body has been common in human cultures throughout history. Early decorations tended to consist of simple art and basic drawings. As society became more technological and sophisticated, the desire for decorations evolved accordingly. The desire has been to move from crude drawings to more sophisticated line art to high gradient, high resolution drawings. As society has become computerized, the demand for decorations that show individual expression has increased. Some tattoo recipients demands have expanded to the level that commonly available, known images and symbols are no longer sufficient. However, it has been difficult for tattooists to consistently meet the higher level expected by those tattoo recipients.

The tattoo art lacked the means to consistently apply a tattoo based on a high quality image without spending significant amounts of time on a given tattoo, which in turn limited the number of tattoos which a tattooist could apply. The art lacks a means to conveniently produce a high quality tattoo stencil to use in the tattoo application process. U.S. Pat. No. 5,816,269 discloses a tattoo stencil mechanism, but the disclosed mechanism does not permit the creation of high quality, high gradient tattoo stencils.

Tattooists sought to use the ThermoFax™ to meet the tattoo recipients expectations. The ThermoFax™ produced tattoo stencils, however it was only capable of producing low resolution line art tattoo stencils without any gradient. Thus it was completely left to the experienced tattooists vision and experience to apply a high quality tattoo using a tattoo stencil from the ThermoFax™. Additionally, the ThermoFax™ requires that the source image be traced before a tattoo stencil is created, further degrading the attempted reproduction of the source image to the tattoo stencil. Moreover, the ThermoFax™ requires frequent maintenance and parts replacement due to the heat involved in producing the tattoo stencils. The current invention seeks to address these deficiencies.

It is an object of this invention to provide a device for creating custom high quality, high resolution tattoo stencils from a source image.

It is another object of this invention to provide a durable, low-maintenance tattoo stencil printer.

It is still a further object of this invention is to provide a process for creating and using high quality, high resolution tattoo stencils.

### SUMMARY OF THE INVENTION

The tattoo stencil printer system is comprised of an impact printer with a specialized print head whose impact is adapted to print to a transfer medium having a pressure sensitive layer, a carrier layer, and a receiving layer adapted for use as a tattoo stencil.

These and other features, aspects, and advantages of the invention will become better understood with reference to the following description, appended claims, and accompanying drawings.

### BRIEF DESCRIPTION OF THE DRAWINGS

FIG. 1 is a perspective view of a print head and a transfer medium according to the current invention.

FIG. 2 provides a cross-sectional view of a print head according to the current invention.

FIG. 3 provides a cross-sectional view of a transfer medium according to the current invention.

FIGS. 4A-4C show common impact curves of print heads.

FIGS. 5A and 5B depict a line art and gradient tattoo stencil from the same source image.

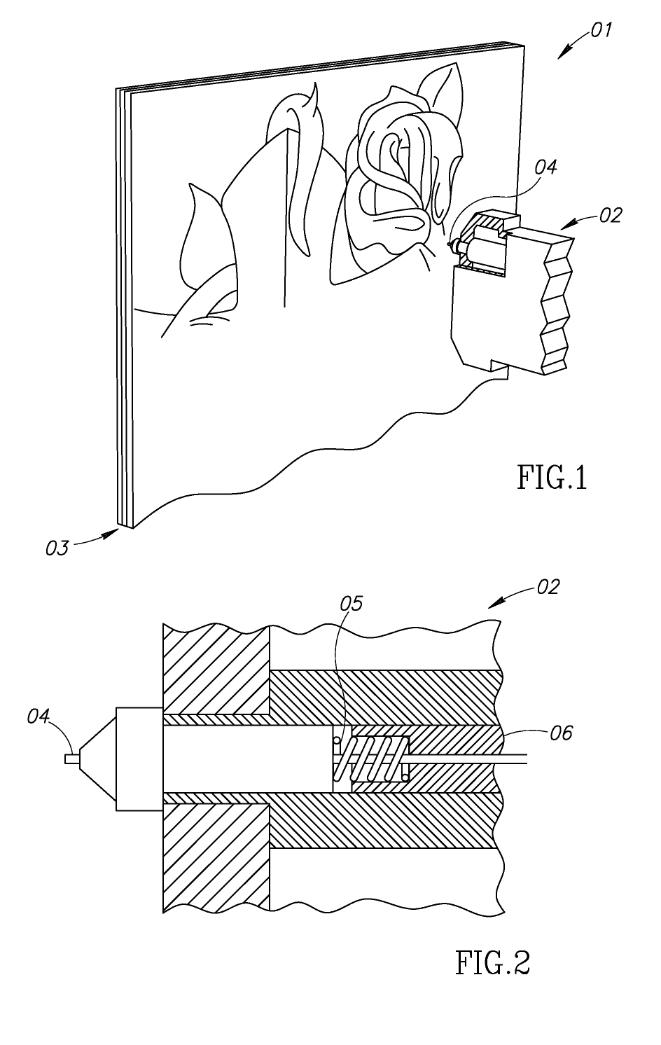

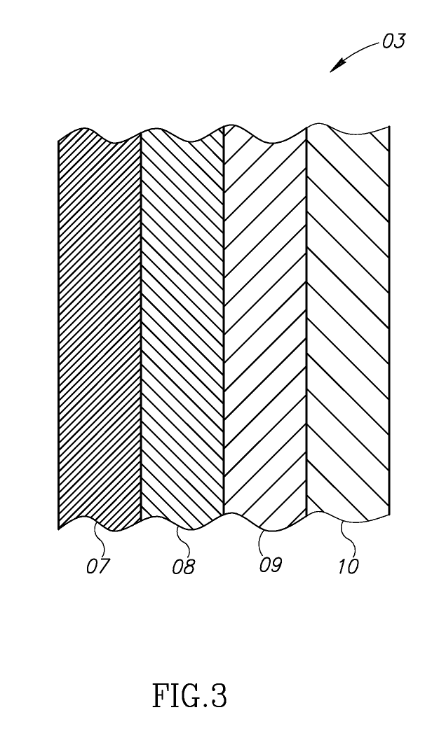

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

One embodiment of the tattoo stencil printer system 01 is comprised of a tattoo stencil printer and a transfer medium 03. The tattoo stencil printer is an impact printer with a specialized print head 02. The impact printer may be any type of impact printer that prints by mechanical impact to a medium, such as a dot matrix printer, a daisy-wheel printer, or a line printer. The preferred impact printer is a dot matrix printer.

The print head 02 for the tattoo printer directly impacts the transfer medium 03 without using an ink source such as a ink ribbon. In order to be suitable as a tattoo stencil printer, the impact of the print head 02 must be adjusted for a particular transfer medium 03. The optimum impact is one which produces a high quality gradient and high resolution with a given image using the print head 02 and transfer medium 03 pairing. If too great an impact is delivered to the transfer medium 03, too much trauma occurs to the transfer medium 03, producing tears in the transfer medium 03. The tears degrade the quality of the image transferred to the transfer medium 03, thus rendering the quality of a tattoo stencil suboptimal for transfer to a receiving surface. If too little impact is delivered to the transfer medium 03, the gradient and resolution of the image transferred to the transfer medium 03 is insufficient for high quality images, again rendering the quality of a tattoo stencil suboptimal for transfer to a receiving surface.

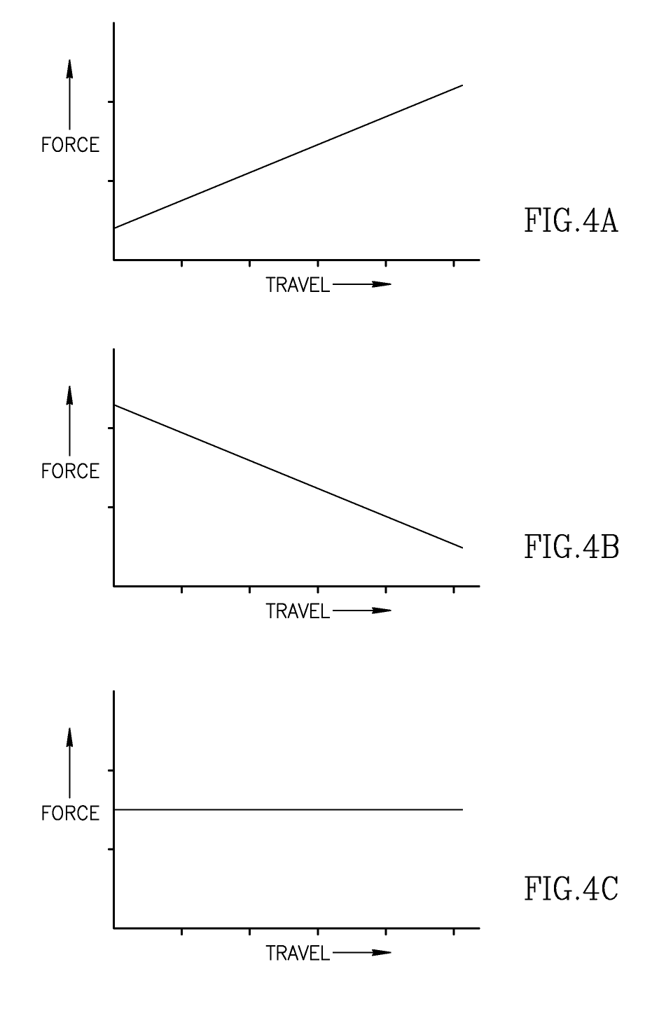

In a dot matrix printer, the impact delivered to the transfer medium 03 may be adjusted by modifying the force delivered to the individual pins 04 contained in the print head 02. Alternatively, the impact delivered to the transfer medium 03 may be adjusted by modifying the distance of the print head 02, and thus the individual pins 04, from the transfer medium 03. To illustrate, different print heads may have different impact curves. For example, FIG. 4A depicts a print head 02 whose pins 04 impact with greater force the further they travel from the print head 02. FIG. 4B depicts a print head 02 whose pins 04 impact with lesser force as they travel from the print head 02. FIG. 4C depicts a print head 02 whose pins 04 impact is constant as they travel from the print head 02. The impact curves for different print heads vary based on such factors the method of activating the pins 04, desired print speed, desired print quality, and desired print media. Preferably, a custom manufactured print head 02 whose impact can be programmatically controlled and its impact force and travel programmatically adjusted. A programmatically controlled print head 02 allows for replication of the impact curves of FIGS. 4A-4C or other possible impact curves, such as a sinusoidal impact pattern. Moreover, a programmatically controlled print head 02 can support an impact curve to pair with the broadest range of transfer media. Programmatic control of the print head 02 parameters permits rapid determination of the necessary impact factors for unknown transfer media, as well as rapid presets for different known transfer media.

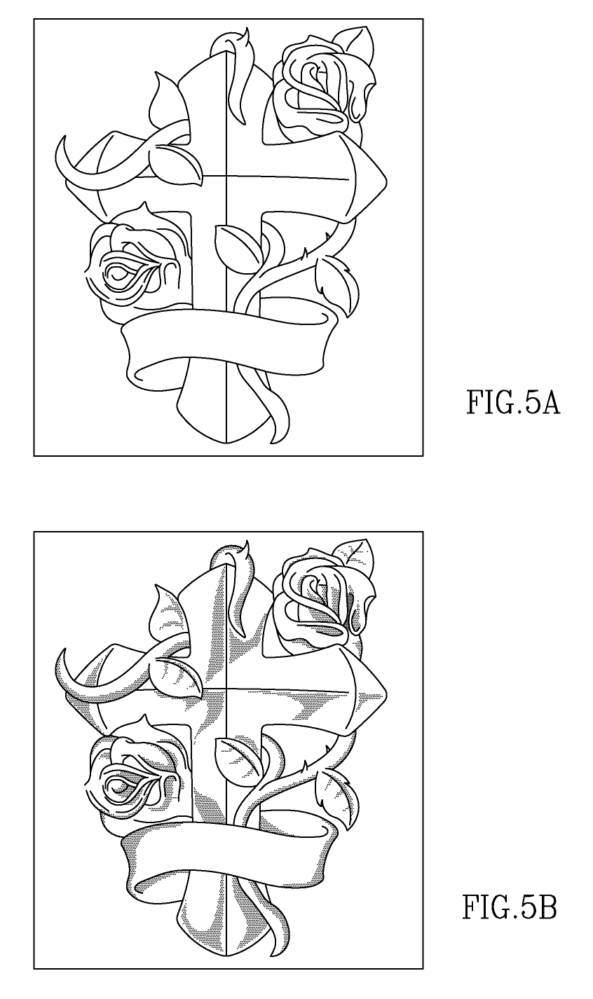

In the alternative, to base a tattoo stencil printer on off-the-shelf components, an existing print head 02 for a dot matrix printer may be employed in this embodiment. The optimum impact can be determined experimentally by varying the position of the print head 02 in relation to the transfer medium 03 and then printing high gradient, high resolution test images. In suboptimal impact, little or no gradient is transferred. A rendition of this state is depicted in FIG. 5A, which is substantially a line art version of a source image. When the highest gradient and resolution are produced without producing excessive trauma to the transfer medium 03, the optimum impact for the print head 02 has been determined and an optimum tattoo stencil will be generated. A rendition of this state is depicted in FIG. 5B, which contains the gradient of the source image, making the tattoo stencil optimum for application of the tattoo.

An additional method to determine optimum impact for an existing dot matrix print head 02 is to examine the impact curve of the print head 02 in relation to the characteristics of a given transfer medium 03. The impact curve for the existing print head 02 is examined and its impact is determined at the point at which the print head 02 strikes the transfer medium 03. If the impact is too high or too low, the existing print head 02 is adjusted. Preferably, the print head's impact is adjusted by altering the print head's distance from the transfer medium 03 to achieve the optimum impact for the given transfer medium 03. In some cases, changing the print head's distance from the transfer medium 03 may not be possible or feasible. For example, some existing print heads do not permit adjustment of the print head's distance from a transfer medium 03. In other cases, the print head 02 may deliver a constant impact throughout its travel, as shown in FIG. 4C, thus adjusting the print head's distance from the transfer medium 03 will have no effect. In such cases, the print head 02 can be adjusted by altering the force that the print head 02 delivers to the pins 04. Where pins 04 are spring 05 activated, the spring 05 tension can be adjusted or a different spring 05 may be substituted. In other cases, the amount of forces the pin driver 06 delivers to the pin 04 may be adjusted. An optimum impact for a specific print head 02 and a specific transfer medium 03 pair is disclosed below, after disclosure on the transfer medium 03.

The transfer medium 03 used in this embodiment is a multilayer composite for receiving an image, preferably multilayer transfer paper. The transfer medium 03 is comprised of a pressure sensitive layer 07 adapted for impact from the print head 02. A carrier layer 08 has a surface which is releasably bonded with an adhesive carrier substrate 09. The adhesive carrier substrate 09 is in contact with a receiving layer 10. The pressure sensitive layer 07 is placed closest to the print head 02. The carrier layer 08 is adjacent to the pressure sensitive layer 07. The adhesive carrier substrate 09 is opposite the surface of the pressure sensitive layer 07. The receiving layer 10 is adjacent to the adhesive carrier substrate 09.

When the pressure sensitive layer 07 is impacted, the bond with the adhesive carrier substrate 09 is disrupted and the adhesive carrier substrate 09 is bonded to the receiving layer 10 at the points of impact. The receiving layer 10 is removed from the transfer medium 03 and adapted for use as a tattoo stencil.

Each layer of the transfer medium 03 can be individually adjusted for optimum cooperation with the print head 02. Characteristics such as the composition or the thickness may be adjusted. For example, the pressure sensitive 07 or carrier layer 08 may be adapted to allow complete transfer of the impact delivered by the print head 02 or to deaden or spread the impact. Alternatively, the pressure sensitive layer 07 may be adapted for optimum impact transfer from pins 04 of different sizes, and thus different impact cross-sections. The adhesive carrier substrate 09 layer may be adapted for stronger adhesion to the carrier layer 08 or receiving surfaces under different impacts. Additionally, the adhesive carrier substrate 09 layer may be altered for better pairing with binding agents. The receiving layer 10 may be adapted for better pairing with a binding agent.

To determine an optimum transfer medium 03 for use in the system, it is necessary to analyze characteristics such as the thickness and composition of the transfer medium 03, the thickness and composition of the receiving layer 10, the adhesive strength of the adhesive carrier substrate 09, the ability of the adhesive carrier substrate 09 to maintain adhesion after application of a binding agent, and the impact characteristics of the print head 02 with which the transfer medium 03 will be paired. A transfer medium 03 with desirable characteristics is thermal spirit stencil paper such as Spirit Master Stencil Paper™.

As disclosed, the print head 02 must be adjusted for a specific print head 02 and a specific transfer medium 03 pairing. In the case of an Okidata Microline® 320 Turbo paired with Spirit Master Stencil Paper™, optimum tattoo stencils were generated with the tattoo stencil printer system 01 when the print head 02 was about two millimeters from the transfer medium 03. Tattoo stencils with a resolution of about 300 dots per inch (DPI) and high gradient were successfully produced with the Okidata Microline® 320 Turbo and Spirit Master Stencil Paper™ combination.

The tattoo stencil printer system 01 is in communication with a personal computer via a serial connection, parallel connection, USB connection, network connection, or other methods known in the art.

Suitable source images on which a tattoo stencil will be based can be created on a personal computer or may be manually created. The source image may be a color or black and white image. Commonly available image editing software, such as Adobe® Photoshop®, Adobe® Elements®, The GNU Image Manipulation Program, or Microsoft Paint, may be used to create an image for use with the system. Manually created images should be converted to a format readable in image editing software by such means as a scanner, camera, or other means known in the art.

The image editing software can communicate with the tattoo stencil printer system 01 through a print driver. If a custom manufactured print head 02 is used in the system, then a custom print driver is preferred for communication with the system. If a modified print head 02 is used in the system, the existing print driver for that print head 02 can be used for communication with the system.

The tattoo stencil printer system 01 can be coupled with a personal computer or may house all of the necessary components for operation in a single device. A self-contained tattoo stencil printer system 01 comprises a tattoo stencil printer, a transfer medium 03, a controller, memory, image software, and a display. Further, the self-contained tattoo stencil printer system 01 is adapted for receipt of external memory, such as media cards, flash cards, jump drives, or the like.

To use the tattoo stencil printer system 01, the desired source image for the tattoo stencil is selected. The selected image is read into the image editing software and sized for the receiving surface. The transfer medium 03 is engaged to the impact printer. Next, the image software is used to communicate the selected image to the impact printer and produce a likeness of the image on the transfer medium 03. The transfer medium 03 is disengaged from the impact printer and the receiving layer 10 of the transfer medium 03 is separated and adapted for use as a tattoo stencil.

The receiving surface is prepared to receive the image from the tattoo stencil. Where the receiving surface is skin, the receiving surface is cleaned and shaved. Next, a binding agent is applied to the receiving surface in order to aid in transfer of the image from the tattoo stencil and to avoid degradation of the image received from the tattoo stencil during the application of the tattoo. A binding agent may be comprised of water, alcohols, soaps, deodorants, or other compositions. Preferred compositions include those which are optimized for use with thermal spirit stencil paper, such as Stencil Stuff™ or Tattoo Stencil Pro Transfer Fluid™. Discussion of binding agents for tattoo stencils is disclosed in U.S. Pat. No. 6,881,253, which is hereby incorporated by reference.

The tattoo stencil is briefly affixed to the receiving surface at the location in which the tattoo will be applied. When the tattoo stencil is removed the adhesive substrate is bonded with the receiving surface, producing a likeness of the source image. A temporary or subcutaneous tattoo can then be applied to the receiving surface, using the likeness as a guide.

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Having thus described the invention, what is claimed as new and desired to be secured by Letters Patent is as follows:

1. An tattoo stencil printer system for the generation of a user-created tattoo stencil to aid in application of tattoos comprising:
An impact printer having at least one print head, said print head's impact to a corresponding transfer medium being suitably adapted to imprint an image on said transfer medium, whereby said transfer medium is suitable for use as a tattoo stencil.

2. The tattoo stencil printer system of claim 1 wherein said impact printer is a dot matrix printer.

3. The tattoo stencil printer system of claim 1 wherein said transfer medium is thermal paper.

4. The tattoo stencil printer system of claim 1 wherein said transfer medium is comprised of a pressure sensitive surface, a carrier medium, and a transfer surface, said transfer surface adapted for receipt of an image.

5. The tattoo stencil printer system of claim 1 wherein said print head is about two millimeters from the transfer medium.

6. The tattoo stencil printer system of claim 1 further comprising memory for retrievable storage of an image, a controller for retrieval, manipulation, and transfer of an image, and a display for visual representation of an image.

7. A process for generating and using a tattoo stencil to aid in application of tattoos comprising the steps of:
(a) providing a tattoo stencil printer, a transfer medium, and an image;
(b) converting the image to a format usable by the tattoo stencil printer;
(c) engaging said transfer medium to the tattoo stencil printer;
(d) transferring said image to the tattoo stencil printer; and
(e) generating a tattoo stencil.

8. The process of claim 7 further comprising the steps of:
(f) providing a receiving surface;
(g) affixing said tattoo stencil to said receiving surface.

9. The process of claim 8 wherein said receiving surface is skin.

10. The process of claim 8 further comprising the steps of applying a tattoo to said receiving surface, whereby said tattoo corresponds to said tattoo stencil.

11. The process of claim 10 wherein said tattoo is temporary.

12. The process of claim 10 wherein said tattoo is subcutaneously applied.
